(19) United States
(12) Patent Application Publication
(10) Pub. No.: US 2011/0114123 A1
(43) Pub. Date: May 19, 2011

(54) DISTANCE INDICATOR

(75) Inventors: Richard J. Gilpatrick, Whitewater, WI (US); Steven C. Crouch, McFarland, WI (US)

(73) Assignee: Briggs & Stratton Corporation, Wauwatosa, WI (US)

(21) Appl. No.: 12/620,590

(22) Filed: Nov. 17, 2009

(51) Int. Cl. B08B 7/04; B08B 13/00; B08B 3/02; G08B 5/00

(52) U.S. Cl. 134/18; 134/113; 340/815.4

(57) ABSTRACT

A method and apparatus utilize a first beam emitter and a second beam emitter coupled to the first beam emitter. The first beam emitter and the second beam emitter move in unison between a plurality of positions to indicate a plurality of distances separating the first beam emitter and the second beam emitter from endpoints of beams emitted by the first beam emitter and the second beam emitter.

### BACKGROUND

Devices used to indicate distances are often inaccurate, complex or space consuming.

### BRIEF DESCRIPTION OF THE DRAWINGS

FIG. 1 is a schematic illustration of a distance indicator in a first state according to an example embodiment.

FIGS. 2A-2C illustrates beam endpoints from coplanar beam emitters of the distance indicator upon a target surface when the distance indicator is at different distances from the target surface.

FIG. 3 is a schematic illustration of the distance indicator of Figure in a second state according to an example embodiment.

FIGS. 4A-4C illustrates beam endpoints from offset beam emitters of the distance indicator upon a vertical target surface when the distance indicator is at different distances from the target surface.

FIGS. 5A-5C illustrates beam endpoints from offset beam emitters of the distance indicator upon a horizontal target surface when the distance indicator is at different distances from the target surface.

FIG. 6 is a top plan view of a fluid sprayer including another embodiment of the distance indicator of FIG. 1 according to an example embodiment.

FIG. 7 is a sectional view of the fluid sprayer of FIG. 6 taken along line 7-7 according to an example embodiment.

FIG. 8 is a top plan view of another embodiment of the fluid sprayer of FIG. 6 according to an example embodiment.

FIG. 9 is a top plan view of still another embodiment of the fluid sprayer of FIG. 6 according to an example embodiment.

FIG. 10 is a front perspective view of another embodiment of the fluid sprayer of FIG. 6 according to an example embodiment.

FIG. 11 is a perspective view of a spray gun and a distance indicator of the fluid sprayer of FIG. 10 according to an example embodiment.

FIG. 12 is an enlarged fragmentary perspective view of the spray gun of FIG. 11 illustrating the distance indicator in more detail.

FIG. 13 is an exploded perspective view of the spray gun of FIG. 11 according to an example embodiment.

FIG. 14 is front elevational view of the spray gun of FIG. 11 according to an example embodiment.

FIG. 15 is a sectional view of the spray gun of FIG. 14 taken along line 15-15.

FIG. 16 is an enlarged fragmentary sectional view of the spray gun of FIG. 15 taken along line 16-16.

### DETAILED DESCRIPTION OF THE EXAMPLE EMBODIMENTS

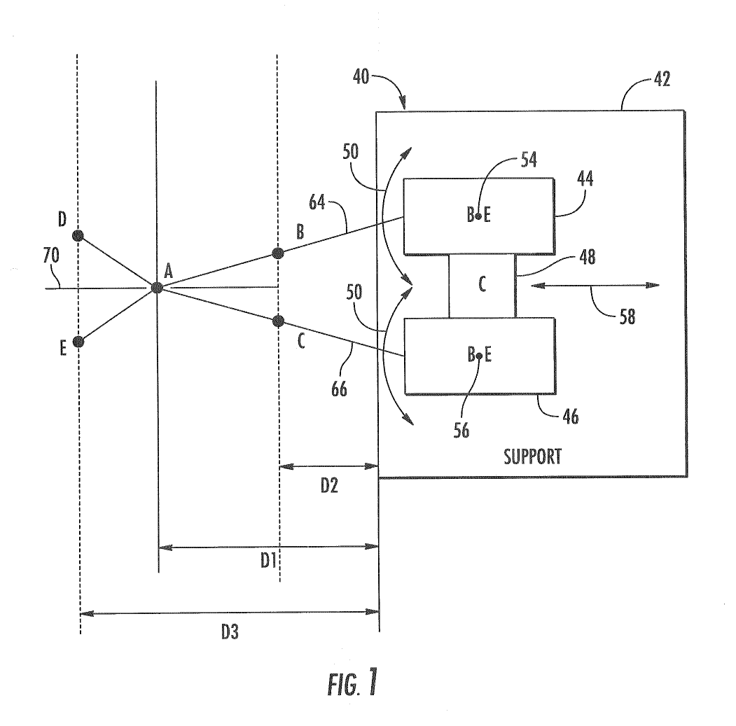

FIG. 1 schematically illustrates a distance indicator 40 according to an example embodiment. As will be described hereafter, distance indicator 40 indicates a distance in a relatively accurate, efficient and compact manner. Distance indicator 40 includes support 42, beam emitter 44, beam emitter 46 and coupling 48.

Support 42 comprises one or more structures configured to support or serve as a base or foundation for beam emitters 44, 46 and coupling 48. In one embodiment, support 42 comprises a base configured to be removably coupled to a device for which distance indication may be beneficial. For example, in one embodiment, support 42 may be configured to be removably coupled to a source of pressurized fluid having a spray gun that receives the pressurized fluid and directs emission of the pressurized fluid. In such an embodiment, distance indicator 40 provides the user with an indication of the distance separating the emission point of the spray gun and the target surface being impinged by the pressurized fluid. Examples of pressurized fluid include liquids and gases. In one embodiment, support 42 is configured to be coupled to a pressure washer or power washer which directs the pressurized water, possibly including additional additives or detergents, at a target surface. In another embodiment, support 42 is configured to be coupled to a paint sprayer. In yet other embodiments, support 42 may be provided as an integral part of the device for which distance indication is beneficial.

Beam emitters 44, 46 comprise devices configured to direct a beam. In one embodiment, beam emitters 44, 46 each include a distinct source of beam propagation material. For example, one embodiment, each of the emitters 44, 46 comprises a source of visible light or electromagnetic radiation such as provided by a light emitting diode. In such an embodiment, beam emitters 44, 46 guide and direct a beam of the light or electromagnetic radiation towards the target surface. In other embodiments, other beam materials may be employed. For example, in other embodiments, beams of fluid, such as water, may be directed at a target surface to indicate distance. In such embodiments, because beam emitters 444, 446 each include a distinct source of beam propagation material, beam splitting components and beam directing portions may be omitted, reducing the complexity, cost and space consumption of distance indicator 40.

In yet other embodiments, beam emitters 44, 46 may share a single source of beam propagation material, wherein the beam propagation material is split and directed in two beams towards the target surface. For example, in one embodiment, beam emitters 44, 46 may comprise appropriate optics and mirrors to split a beam of light and direct beam the light as two distinct beams. In such an embodiment, two optical members, such as two mirrors, guide the two beams and are rotatable or pivotable in unison with one another in opposite directions.

Coupling 48 comprises one or more structures serving as a mechanism for movably supporting or movably coupling beam emitters 44, 46 for movement relative to one another in the directions indicated by arrows 50. Coupling 48 is configured to operatively couple the emitters 44 and 46 to one another such a beam emitters 44, 46 rotate or pivot in opposite directions about axes 54, 56, respectively, in unison with one another. In other embodiments, rather than emitters 44, 46 each pivoting about a single axis, emitters 44, 46 may move in unison with one another in opposite directions, each emitter moving about multiple axes or along an arc.

According to one embodiment, coupling 48 is further configured to operatively join or connect beam emitters 44, 46 to one another and to support 42 such that beam emitters 44, 46 are also movable in unison with one another in the directions indicated by arrows 58. For example, coupling 48, while facilitating rotation of beam emitters 44, 46 may also facilitate sliding movement of both emitters 44, 46 relative to support 42. In such embodiments, coupling 48 further facilitates concurrent movement of beam emitters 44, 46 in unison with one another in a linear fashion towards and away from a target surface. As a result, more finite, micro-adjustments to more precisely control distance indications may be provided by distance indicator 40. In other embodiments, coupling 48 may omit movement of beam emitters 44, 46 in the direction of arrows 58.

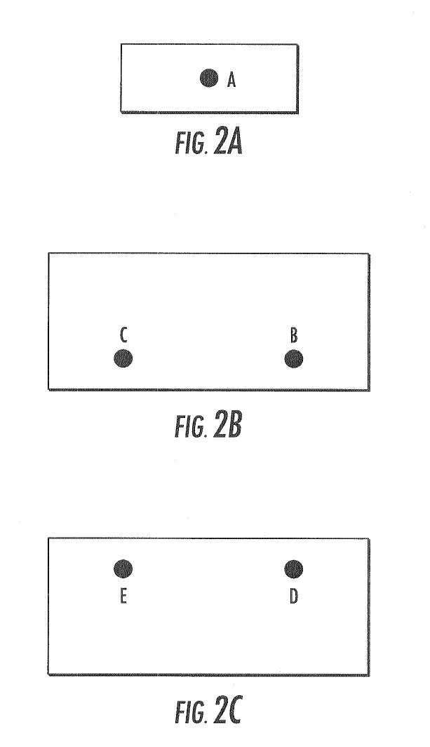

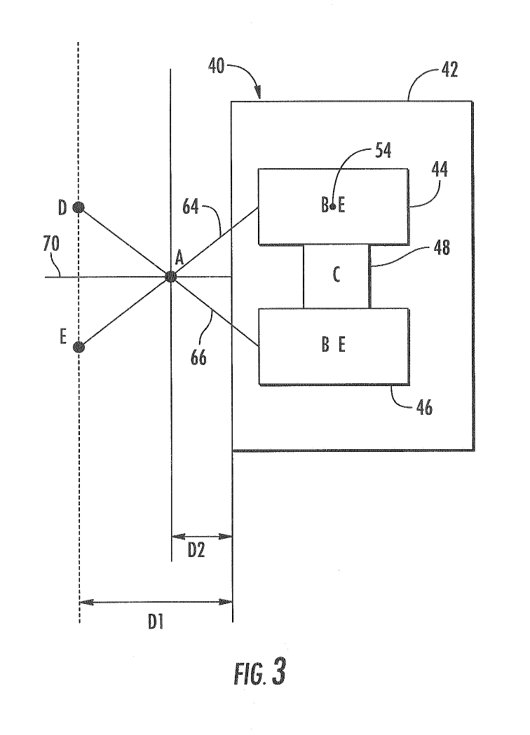

FIGS. 1-3 further illustrate operation of distance indicator 40. FIG. 1 illustrates beam emitters 44, 46 directing beams 64, 66, respectively, at angles such that beams 64, 66 converge at a distance D1 spaced from beam emitters 44, 46. In other words, as shown by FIGS. 1 and 2A, when beam emitters 40, 46, distance indicator 40 or the device to which distance indicator 40 is mounted or provided are spaced or distanced from a target surface by the distance D1, the endpoints of beams 64 and 66 converge at a single point A on the target surface. Alternatively, as shown by FIGS. 1 and 2B, if beam emitters 40, 46 are spaced from a target surface by distance D2 less than D1, the endpoints of beam 64, 66 do not converge but instead form two distinct spots or points B and C on the target surface. Likewise, as shown by FIGS. 1 and 2C, if beam emitters 40, 46 are spaced from a target surface by distance D3 greater than D1, the endpoints of beam 64, 66 do not converge but instead form two distinct spots or points D and E on the target surface. Thus, if the desired distance between beam emitters 44, 46 and the target surface is D1, a person simply moves distance indicator 40 or the device provided with distance indicator 40 towards and away from the target surface until beams 64, 66 have endpoints converging at a single spot A.

As shown to by FIG. 3, if the desired distance between beam emitters 44, 46 and the target surface is D2, beam emitters 44, 46 are moved in unison in opposite directions to change the angle at which beams 64 and 66 are emitted. In the example illustrated, since distance D2 is less than the previous distance D1, emitter 44 is rotated in a counter-clockwise direction (as seen in FIG. 3) end beam emitter 46 is rotated in a clockwise direction. As a result, the endpoints of beams 64 and 66 now converge at a single point or spot A on the target surface when the spacing between the target surface and beam emitters 44, 46 is distance D2. Because both emitters 44 and 46 move in unison with one another and enough to directions, the convergence point A of beam 64, 66 at both the distances D1 and D2 lies along the same axis 70. In one embodiment, axis 70 may be aligned with the axis along which pressurized fluid is directed (the axis of the spray gun) to more accurately indicate the distance at which pressurized fluid is delivered to the target distance.

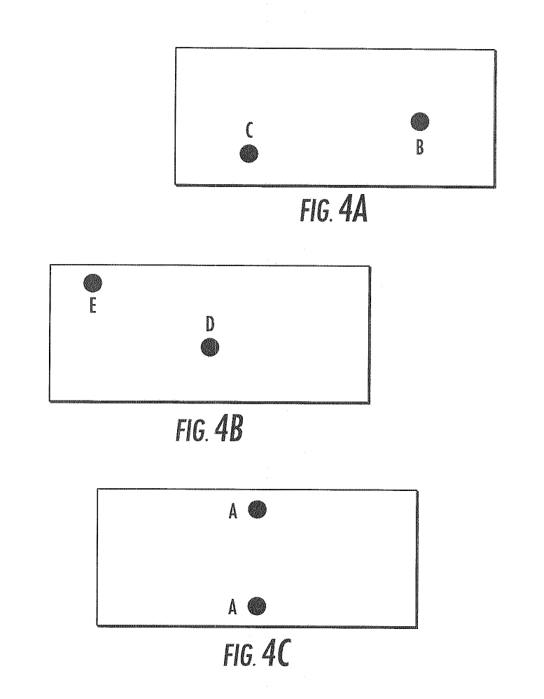

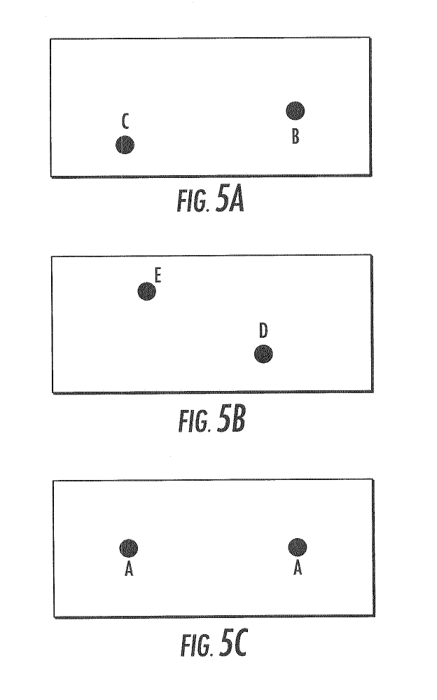

In the example illustrated in FIGS. 1-3, beam emitters 44 and 46 and beams 64, 66 are in a common or same plane. In other embodiments, beam emitters 44, 46 may be supported in offset planes, vertically or horizontally. In such embodiments, distance indicator 40 indicates that the desired distance is attained when the endpoints of beam 64, 66 former spots on the target surface that are aligned along a single linear horizontal or vertical axis. FIGS. 4A-4C illustrate the endpoints are spots of beam 64, 66 when emitters 44, 46 are supported at different vertical heights or are in different horizontal planes with respect to one another. When the target surface is a vertical surface, distance indicator 40 or the device provided with distance indicator 40 is at the desired spacing from the target surface when the spots are in vertical alignment as shown by the two aligned spots A in FIG. 4C. When the target surface is a horizontal surface, distance indicator 40 or the device provided with distance indicator 40 is at the desired spacing from the target surface when the spots are in horizontal alignment as shown by the two aligned spots A in FIG. 5C.

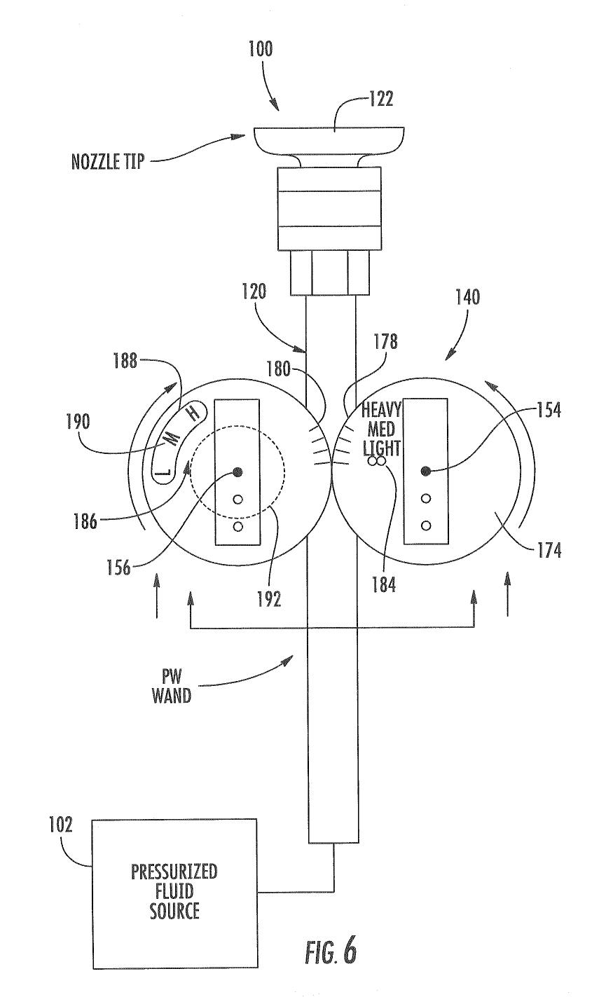

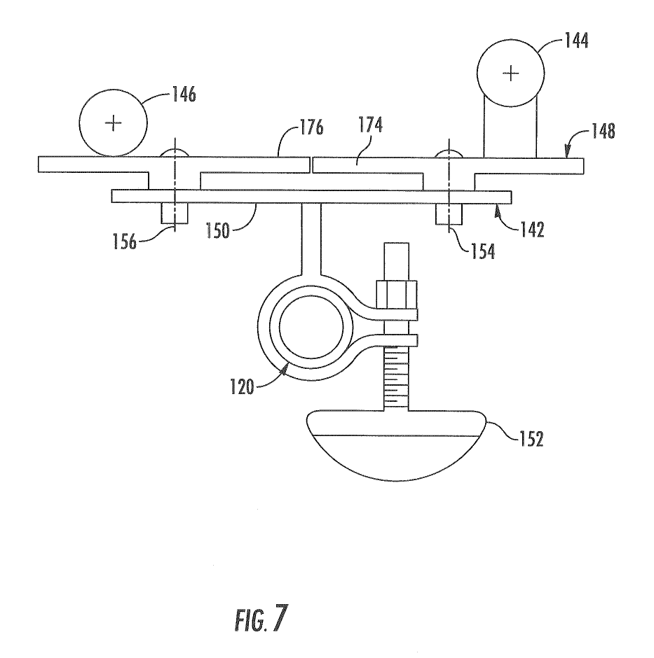

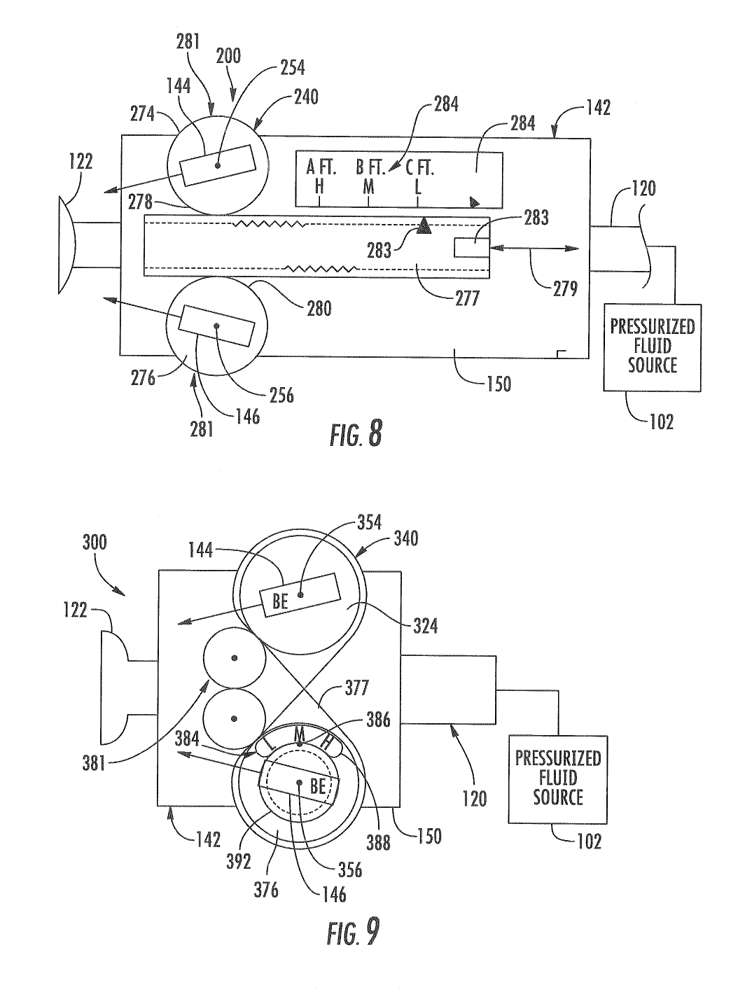

FIGS. 6 and 7 illustrate fluid sprayer 100 provided with a distance indicator 140 according to an example embodiment. In addition to distance indicator 140, fluid sprayer 100 includes a source of pressurized fluid 102 (schematically shown) and an emission wand or spray gun 120 have a nozzle tip 124. Pressurized fluid source 102 pressurized his fluid (liquid, gas or a combination thereof) and supplies a fluid to spray gun 120 which directs pressurized fluid through nozzle 122. Spray gun 120 may have multiple other configurations.

Distance indicator 140 is removably mounted to spray gun 120 and indicates a distance at which the target surface that will be or that is being impinged by the pressurized fluid from nozzle tip 122 is separated from distance indicator 140 as well as nozzle tip 122. For purposes of this disclosure, the term “removably” means that one member may be separated from another member without damage to either member. Like distance indicator 40, distance indicator 140 indicates a distance in a relatively accurate, efficient and compact manner. Distance indicator 140 comprises support 142, beam emitters 144, 146 and coupling 148.

Support 142 comprises one or more structures configured to support or serve as a base or foundation for beam emitters 144, 146 and coupling 148. Support 142 comprises a base removably coupled to spray gun 120. In the example illustrated, support 142 includes a platform 150 and the underlying clamping mechanism 152. Platform 150 supports coupling 148. Clamping mechanism 152 clamps about a tube or barrel of spray gun 120. Although support 142 is illustrated as including a clamping mechanism 152 using a threaded clamp, in other embodiments, support 142 may include other clamping mechanisms or may include other structures configured to releasably secure distance indicator 140 to spray gun 120.

Beam emitters 144, 146 comprise devices configured to direct a beam. Beam emitters 144, 146 each include a distinct source of beam propagation material. In particular, beam emitters 144, 146 each include a source of visible light or electromagnetic radiation such as a light emitting diode.

Coupling 148 comprises one or more structures serving as a mechanism for movably supporting or movably coupling beam emitters 144, 146 to one another such that beam emitters 144, 146 rotate or pivot in opposite directions about axes 154, 156 (shown in FIG. 7), respectively, in unison with one another. Coupling 148 comprises disks 174, 176. Disk 174 comprises a structure pivotally or rotationally supported by platform 150 for rotation about axis 154 while supporting beam emitter 144. Likewise, disk 176 comprises a structure pivotally or rotationally coupled to platform 150 for rotation about axis 156 while supporting beam emitter 146.

For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members. The term “fluidly coupled” shall mean that two are more fluid transmitting volumes are connected directly to one another or are connected to one another by intermediate volumes or spaces such that fluid may flow from one volume into the other volume.

Disks 174 and 176 include curved or circular outer perimeter portions 178 and 180, respectively, which are in contact with one another during rotation of disks 174, 176 such that rotation of one of disks 174, 176 results in concurrent rotation of the other of disks 174, 176. In one embodiment, perimeter portions 178, 180 each include intermeshing teeth. In another embodiment, perimeter portions 178, 180 have roughened or smooth surfaces that frictionally engage one another.

In one embodiment, disks 174, 176 are each circular in shape. In another embodiment, one or both of disks 174, 176 comprise partial disks that have portions other than perimeter portions over 178, 180 which are not curved or circular and which do not engage one another. For example, in one embodiment, one or both of disks 174, 176 may alternatively be semicircular in shape, wherein the circular portions of disks 174, 176 contact and engage one another.

As further shown by FIG. 6, distance indicator 140 additionally includes indicia 184. Indicia 184 provide an indication of the distance at which the beams from emitters 144, 146 will either converge in a single spot or point or will align with one another depending upon the plane in which emitters 144, 146 are supported. As shown by FIG. 7, in the example illustrated, beam emitters 144, 146 are supported in offset horizontal planes such that the desired distance is achieved when the spots from emitters 144, 146 become aligned as shown above in FIG. 4C or 5C depending upon the orientation of the target surface.

In the example illustrated, indicia 184 comprise indicium provided on each of disks or 174, 176 so as to rotate with and be carried by disks 174, 176. The indicated distance adjacent a pair of aligned or touching indicium is the distance at which the beams from emitters 144, 146 will be aligned. In the example illustrated, indicia 184 provide qualitative indications of the density or intensity of the fluid impinging the target surface, heavy, medium and light. In other embodiments, indicia 184 may alternatively provide numerical distance measurements or other distance related information.

In other embodiments, indicia indicating the currently set distance corresponding to the currently set relative angular position of emitters 144, 146 may be provided at other locations and in other fashions. For example, as shown by FIG. 6, distance indicator 140 may additionally or alternatively include a pointer 186 and a support 188 including indicia 190. Pointer 186 is operably coupled to disk 176 so as to rotate with disk 176. Support 188 comprises a stationary or fixed surface carrying indicia 190 which indicate the distance at which the beams from emitters 144, 146 will be aligned. In one embodiment, support 188 may comprise a housing at least partially enclosing disks 174, 176. In other embodiments, support 188 may comprise other surfaces that remain stationary during rotation of disks 174, 176.

As shown by FIG. 6, in one embodiment, pointer 186 may extend from a dial 192 operatively connected to one of disks 174, 176. Dial 192 enables a person or user to manually grasp dial 192 to rotate disks 174, 176. In other embodiments, disks 174, 176 may be manually rotated in other manners, such as by a person contacting a perimeter edge of one of disks 174, 176. In still other embodiments, powered mechanisms, such as and electric solenoid or motor, may be used to rotate disks 174, 176 between different relative angular positions.

FIG. 8 illustrates fluid sprayer 200 provided with a distance indicator 240 according to an example embodiment. In addition to distance indicator 240, fluid sprayer 200 includes a source of pressurized fluid 102 (schematically shown) and the emission wand or spray gun 120 has a nozzle tip 124. Pressurized fluid source 102 and spray gun 120 are described above.

Distance indicator 240 is removably mounted to spray gun 120 and indicates a distance at which the target surface that will be or that is being impinged by the pressurized fluid from nozzle tip 122 is separated from distance indicator 140 as well as nozzle tip 122. Like distance indicator 40, distance indicator 240 indicates a distance in a relatively accurate, efficient and compact manner. Distance indicator 240 is similar to distance indicator 140 except the distance indicator 240 includes coupling 248 in place of coupling 148.

Coupling 248 comprises one or more structures serving as a mechanism for movably supporting or movably coupling beam emitters 144, 146 such that beam emitters 144, 146 rotate or pivot in opposite directions about axes 254, 256, respectively, in unison with one another. Coupling 148 comprises disks 274, 276 and translating coupler 277. Disk 274 comprises a structure pivotally or rotationally coupled to platform 150 for rotation about axis 254 while supporting beam emitter 144. Likewise, disk 276 comprises a structure pivotally or rotationally coupled to platform 150 for rotation about axis 256 while supporting beam emitter 146. Disks 274 and 276 include curved or circular outer perimeter portions 278 and 280, respectively, which are in contact with translating coupler 277 during rotation of disks 274, 276 such that rotation of one of disks 274, 276 results in concurrent rotation of the other of disks 274, 276.

In one embodiment, disks 274, 276 are each circular in shape. In another embodiment, one or both of disks 274, 276 have portions other than perimeter portions 278, 280 which are not curved or circular and which do not engage translating coupler 277. For example, in one embodiment, one or both of disks 274, 276 may alternatively be semicircular in shape, wherein the circular portion of each of disks 274, 276 contact and engage one translating coupler 277.

Translating coupler 277 comprises a member slidably supported along platform 150 for linear translation and reciprocation in the direction indicated by arrows 279 while in concurrent engagement with both of disks 274, 276 so as to concurrently rotate disks 274, 276 in unison and in opposite directions. In one embodiment, coupler 277 includes a handle 283 facilitating manual movement of coupler 277. In the example illustrated, translating couple 277 extends between disks 274, 276 and between their rotational axes 254, 256 while in concurrent engagement with both disks 274, 276. In another embodiment, translating coupler 277 may have a shape of a goalpost, wherein the spaced parallel legs of the goalpost engage the outermost opposite sides 281 of disks 274, 276 such that linear reciprocation of coupler 277 rotate disks 274, 276 in unison and in opposite directions. In one embodiment, translating coupler 277 frictionally engages disk 274, 276. In yet another embodiment, translating coupler 277 comprises a rack gear having teeth that intermesh with teeth of disks 274, 276. In the embodiment shown, the teeth face away from one another on opposite sides of coupler 277. In embodiments where coupler 277 engages outermost sides or perimeter portions 281 of disks 274, 276, such teeth face towards one another.

As further shown by FIG. 8, distance indicator 240 additionally includes pointer 283 and indicia 284. Porter 283 is provided on coupler 277. Indicia 284 are provided upon a support 285 which is stationarily supported with respect to coupler 277. Indicia 284 provide an indication of the distance at which the beams from emitters 144, 146 will either converge in a single spotter point or will align with one another depending upon the plane in which emitters 144, 146 are supported. In the example illustrated, indicia 184 provide qualitative indications of the density or intensity of the fluid impinging the target surface, heavy, medium and light. In other embodiments, indicia 184 may alternatively provide numerical distance measurements or other distance related information.

In other embodiments, indicia indicating the currently set distance corresponding to the currently set relative angular position of emitters 144, 146 may be provided at other locations and in other fashions. For example, distance indicator 240 may additionally or alternatively include a pointer 186 and a support 188 including indicia 190 as shown and described above with respect to FIG. 6. Pointer 186 is operably coupled to disk 276 so as to rotate with disk 276. Support 188 comprises a stationary or fixed surface carrying indicia 190 which indicate the distance at which the beams from emitters 144, 146 will be aligned. In one embodiment, support 188 may comprise a housing at least partially enclosing disks 274, 276. In other embodiments, support 188 may comprise other surfaces that remain stationary during rotation of disks 274, 276.

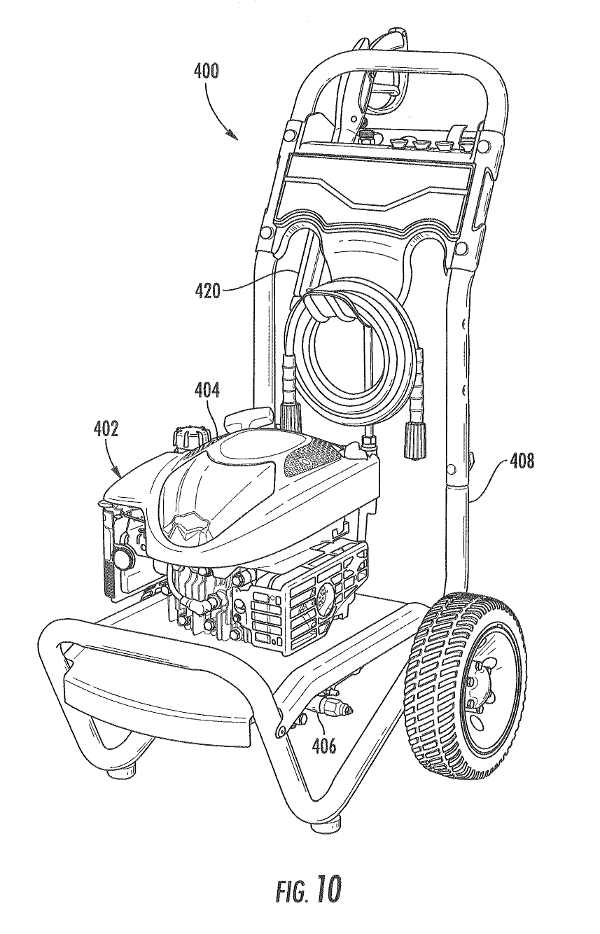

FIG. 9 illustrates fluid sprayer 300 provided with a distance indicator 340 according to an example embodiment. In addition to distance indicator 340, fluid sprayer 300 includes a source of pressurized fluid 102 (schematically shown) and the emission wand or spray gun 120 having a nozzle tip 124. Pressurized fluid source 102 and spray gun 120 are described above.

Distance indicator 340 is removably mounted to spray gun 120 and indicates a distance at which the target surface that will be or that is being impinged by the pressurized fluid from nozzle tip 122 is separated from distance indicator 140 as well as nozzle tip 122. Like distance indicator 40, distance indicator 340 indicates a distance in a relatively accurate, efficient and compact manner. Distance indicator 340 is similar to distance indicator 140 except the distance indicator 340 includes coupling 348 in place of coupling 148.

Coupling 348 comprises one or more structures serving as a mechanism for movably supporting or movably coupling beam emitters 144, 146 such that beam emitters 144, 146 rotate or pivot in opposite directions about axes 354, 356, respectively, in unison with one another. Coupling 348 comprises disks 374, 376 and belt 377. Disk 374 comprises a structure pivotally or rotationally coupled to platform 150 for rotation about axis 354 while supporting beam emitter 144. Likewise, disk 376 comprises a structure pivotally or rotationally coupled to platform 150 for rotation about axis 356 while supporting beam emitter 146.

Belt 377 comprises a band, rope, cord, wire or the like twisted and wrapped about disks 374, 376 so as to concurrently rotate disks 274, 276 in unison and in opposite directions. In one embodiment, disks 374, 376 comprise pulleys. In another embodiment, disks 374, 376 each comprise a toothed pulley or gear, wherein belt 377 comprises a tooth belt. In the example illustrated, belt 377 is twisted so as to have a FIG. 8 shape. In other embodiments, doubt 377 may have additional bends or twists.

As shown by FIG. 9, distance indicator 340 may alternatively include a gear train 381 in place of belt 377. Gear train includes two or more gears operatively coupled between disks 374, 376 so as to concurrently rotate disks 274, 276 in unison and in opposite directions.

As further shown by FIG. 9, distance indicator 340 additionally includes indicia 384. Indicia 384 provide an indication of the distance at which the beams from emitters 144, 146 will either converge in a single spotter point or will align with one another depending upon the plane in which emitters 144, 146 are supported. Indicia 384 provide qualitative indications of the density or intensity of the fluid impinging the target surface, heavy, medium and light. In other embodiments, indicia 384 may alternatively provide numerical distance measurements or other distance related information.

Distance indicator 340 includes a pointer 386 and a support 388 including indicia 384. Pointer 386 is operably coupled to disk 376 so as to rotate with disk 376. Support 388 comprises a stationary or fixed surface carrying indicia 384 which indicate the distance at which the beams from emitters 144, 146 will be aligned. In one embodiment, support 388 may comprise a housing at least partially enclosing disks 374, 376. In other embodiments, support 388 may comprise other surfaces that remain stationary during rotation of disks 374, 376.

As shown by FIG. 9, in one embodiment, pointer 386 may extend from a dial 392 operatively connected to one of disks 374, 376. Dial 392 enables a person or user to manually grasp dial 392 to rotate disks 374, 376. In other embodiments, disks 374, 376 may be manually rotated in other manners, such as by a person contacting a perimeter edge of one of disks 374, 376. In still other embodiments, powered mechanisms, such as and electric solenoid or motor, may be used to rotate disks 374, 376 between different relative angular positions.

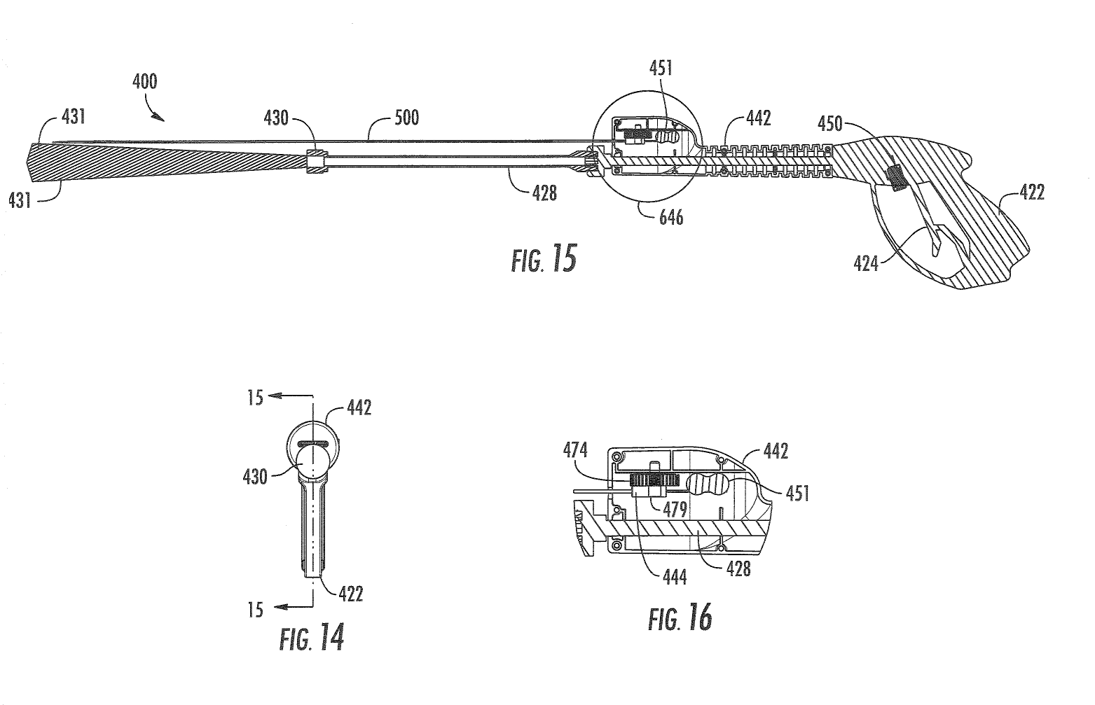

FIGS. 10-16 illustrate fluid sprayer 400 provided with a distance indicator 440 according to an example embodiment. In addition to distance indicator 440, fluid sprayer 400 includes a source of pressurized fluid 402 and an emission wand or spray gun 420 have a nozzle tip 424. Pressurized fluid source 402 pressurizes fluid (liquid, gas or a combination thereof) and supplies a fluid to spray gun 420 which directs pressurized fluid through nozzle 422. In the example illustrated, pressurized fluid source 402 comprises an internal combustion engine 404 which drives a fluid pump 406 to pressurize water (and potentially additional additives). According to one embodiment, the pump 406 comprises a pump at least similar to the pump shown and described in U.S. Pat. No. 6,092,998 to Dexter et al. which issued on Jul. 25, 2000, the full disclosure of which is hereby incorporated by reference. The internal combustion engine 404 and the pump 406 are supported by a stand 408. In other embodiments, the internal combustion engine 404, the pump 406 and the stand 408 may have other configurations.

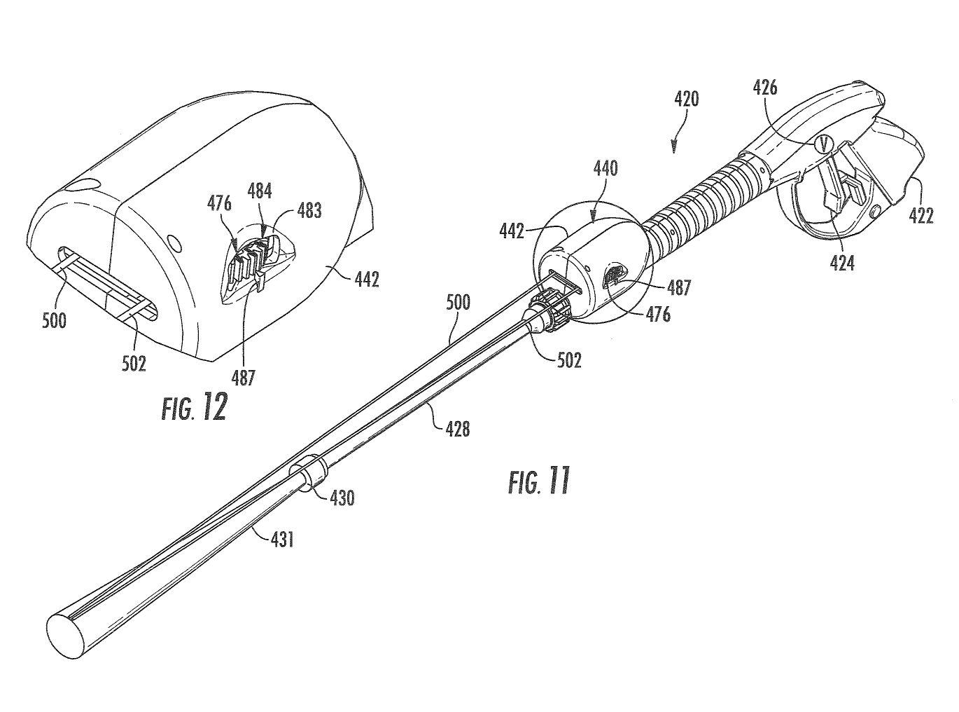

Spray gun 420 is fluidly connected to pump 406 and receive pressurized fluid from pump 406. As shown by FIG. 11, spray gun 420 comprises handle 422, trigger 424, valve 426, barrel 428 and nozzle 430. Handle 422 facilities gripping of spray gun 420. Trigger 424 comprises a manually actuatable trigger operatively connected to valve 426 to selectively open and close valve 426. Valve 426, schematically shown, actuates between a fully closed state and a fully open state in response to depressment, pivoting or other actuation of trigger 424. Valve 426 regulates the flow of the pressurized fluid to barrel 428. Barrel 428 delivers the pressurized fluid to nozzle 430 which emits the fluid 431. In other embodiments, spray gun 420 may have other configurations and may operate in alternative fashions.

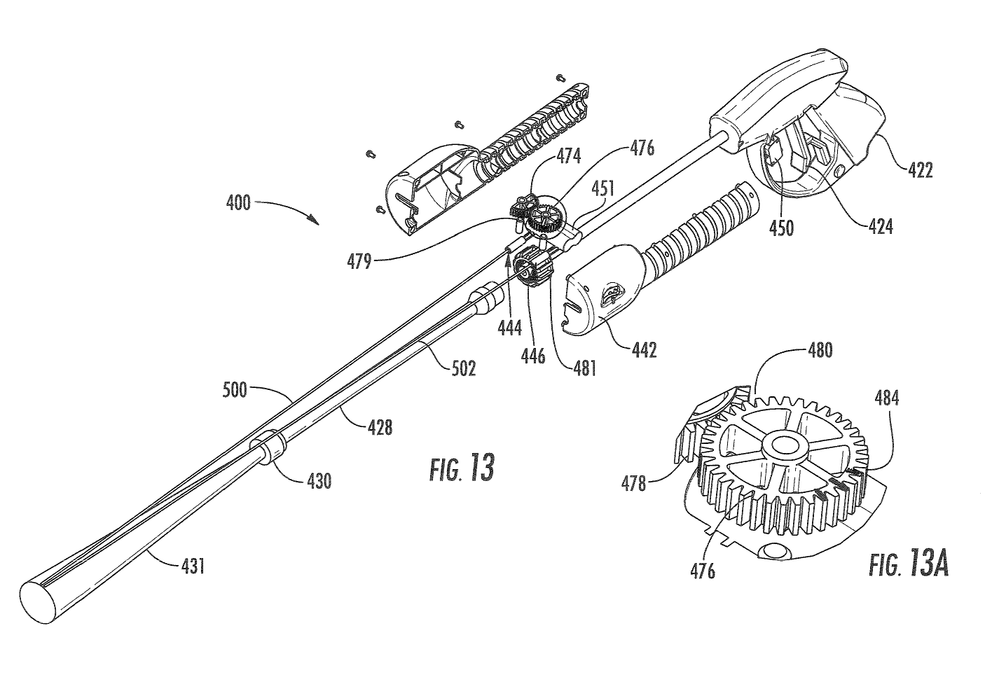

Distance indicator 440 indicates a distance at which the target surface that will be or that is being impinged by the pressurized fluid from nozzle tip 430 is separated from distance indicator 440 as well as nozzle tip 430. Like distance indicator 40, distance indicator 440 indicates a distance in a relatively accurate, efficient and compact manner. As shown by FIGS. 13-16, distance indicator 440 comprises support 442, beam emitters 444, 446, coupling 448 and switch 450 (shown in FIGS. 13 and 14). Support 442 comprises one or more structures configured to support or serve as abuse or foundation for beam emitters 444, 446 and coupling 448. Support 442 comprises a housing extending about barrel 428.

Beam emitters 444, 446 comprise devices configured to direct abeam. Beam emitters 444, 446 each include a source of visible light or electromagnetic radiation such as a light emitting diode. The emitters 444, 446 are each powered by a battery pack 451.

Coupling 448 movably supports or movably couples beam emitters 444, 446 such that beam emitters 444, 446 rotate or pivot in opposite directions in unison with one another. As shown by FIG. 13, coupling 448 comprises disks 474, 476. Disk 474 comprises a structure pivotally or rotationally supported by a 479 supported by support 422 while supporting beam emitter 444. Likewise, disk 476 comprises a structure pivotally or rotationally supported by a shaft 481 supported by support 422 while supporting beam emitter 446. Disks 474 and 476 include curved or circular outer perimeter portions 478 and 480, respectively, which are in contact with one another during rotation of disks 474, 476 such that rotation of one of disks 474, 476 results in concurrent rotation of the other of disks 474, 476. In the embodiment illustrated, perimeter portions 478, 480 each include intermeshing teeth. In another embodiment, perimeter portions 478, 480 have roughened or smooth surfaces that frictionally engage one another.

In the embodiment illustrated, disks 474, 476 are each circular in shape. In another embodiment, one or both of disks 474, 476 may comprise partial disks that have portions other than perimeter portions 478, 480 which are not curved or circular and which do not engage one another. For example, in one embodiment, one or both of disks 474, 476 may alternatively be semicircular in shape, wherein the circular portion of each of disks 474, 476 contact and engage one another.

As shown by FIG. 12, housing 442 includes an opening 483 through which disk 476 extends. Opening 483 provides access to disk 476, allowing a person to use his or her fingers to manually rotate disk 476, whereby disk 474 is also rotated. The teeth of disk 476 facilitate greater control over the manual rotation of disk 476. As a result, the angles at which beams 500, 502 are directed towards a target surface may be adjusted. Because both disks 474, 476 rotate in unison and in opposite directions to rotate or reposition both emitters 444, 446, more precise control over the angular adjustment of emitters before 44, 446 and the direction of beams 500, 502 may be achieved. In other embodiments, disks 474, 476 may be rotated in other fashions. For example, disks 474, 476 may be rotated with a dial coupled to one of disks 474, 476 (as shown and described above), may be rotated with a translating coupler (as shown and described above) or may be rotated with a powered actuator. Moreover, distance indicator 440 may include other couplings such as those alternative couplings described above.

As further shown by FIGS. 12 and 13A, distance indicator 440 additionally includes indicia 484. Indicia 484 provide an indication of the distance at which the beams 500, 502 from emitters 444, 446 will either converge in a single spotter point or will align with one another depending upon the plane in which emitters 444, 446 are supported. In the example illustrated, indicia 484 comprise indicium provided on disk 476 so as to rotate with and be carried by disk 476. Indicia 484, when aligned with pointer 487 provided on housing 442, provides qualitative indications of the density or intensity of the fluid impinging the target surface, heavy, medium and light. In other embodiments, indicia 484 may alternatively provide numerical distance measurements or other distance related information. In other embodiments, indicia indicating the currently set distance corresponding to the currently set relative angular position of emitters 444, 446 may be provided at other locations and in other fashions.

Switch 450 comprises a switch operatively coupled to trigger 424 and operatively coupled to beam emitters 444, 446. Switch 450 is configured to generate electrical signals turning on or actuating emitters 444, 446 in response to initial depressment of trigger 424. In one embodiment, switch 450 generates such electrical signals turning on or actuating emitters 444, 446 in response to initial actuation of trigger 424, but before trigger 424 has been sufficiently actuated (depressed, pulled, pushed or the like) so as to actuate valve from a closed state. As a result, when a person initially actuates trigger 424, beams 500, 502 will be projected onto the target surface prior to the ejection of pressurized fluid onto the target surface. Consequently, the person using device 400 receives a preview indicating the current distance from the target surface, allowing the person to reposition nozzle 430 of spray gun 420 with respect to the target surface prior to any further depressment or other actuation of trigger 424 and prior to any actual impingement of the target surface with pressurized fluid. When spray gun 420 is subsequently positioned at the exact desired distance from the target surface, as indicated by convergence or alignment of beams 500, 502, the person may fully actuator depressed trigger 424 to cause the ejection of pressurized fluid onto the target surface.

In other embodiments, it lieu of switch 450 transmitting electrical signals to beam emitters 444, 446, switch 450 may alternatively comprise a mechanical switch which mechanically actuates or turns on beam emitters 444, 446 in response to initial actuation of trigger 424. In yet other embodiments, such turn on signals may be transmitted optically or wirelessly.

In still other embodiments, switch 450 may be omitted or other switching or sensing mechanisms may be employed. For example, beam emitters 444, 446 may alternatively be turned on when the pressurized fluid 431 is ejected from spray gun 420. In other embodiments, beam emitters 444, 446 may alternatively be turned on and off independent of actuation of trigger 424.

In particular embodiments, switch 450 may additionally be configured to continuously sense the positioning of trigger 424, wherein different electrical signals are transmitted to beam emitters 444, 446 depending upon the extent to which trigger 424 has been actuated. For example, switch 450 may comprise a potentiometer or similar sensing device. In one embodiment, emitters 444, 446 emit or cause the discharge of beams having different characteristics based on the different signals received from switch 450 which is dependent upon the extent to which trigger 424 has been actuated. For example, as trigger 424 is actually different extents, changing the volume or velocity of pressurized fluid being ejected through nozzle 430, beams 500, 502 emitted by beam emitters 444, 446, respectively, may have different characteristics. In embodiments where beams 500, 502 comprise visible light beams, beams 500, 502 may have different intensities or brightnesses or may have different colors depending upon the extent to which trigger 424 has been actuated.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a first beam emitter;
a second beam emitter coupled to the first beam emitter so as to move in unison with the first beam emitter between a plurality of positions to indicate a plurality of distances separating the first beam emitter and the second beam emitter from endpoints of beams emitted by the first beam emitter and the second beam emitter.

2. The apparatus of claim 1, wherein the first beam emitter and the second beam emitter rotate in opposite directions and in unison relative to one another between the plurality of positions.

3. The apparatus of claim 1 comprising:
a first at least partial disk rotationally supporting the first beam emitter; and
a second at least partial disk rotationally supporting the second beam emitter, wherein the first disk and the second disk are operably coupled to one another so as to rotate in unison and in opposite directions.

4. The apparatus of claim 3, wherein the first disk and the second disk have perimeters in contact with one another.

5. The apparatus of claim 4, further comprising indicia carried by the first disk corresponding to the plurality of distances.

6. The apparatus of claim 4 further comprising:
a dial coupled to the first disk; and
angularly arranged indicia stationarily supported with respect to the dial corresponding to the plurality of distances.

7. The apparatus of claim 3, wherein the first disk and the second disk have perimeters with teeth and wherein the apparatus further comprises a rack gear having teeth in meshing engagement with the teeth of the first disk and in meshing engagement with the teeth of the second disk.

8. The apparatus of claim 7 further comprising a linearly arranged indicia stationarily supported with respect to the rack gear corresponding to the plurality of distances.

9. The apparatus of claim 3 further comprising a belt coupled to the first disk and the second disk and having a FIG. 8 shape.

10. The apparatus of claim 8 further comprising:
a dial coupled to the first disk; and
angularly arranged indicia stationarily supported with respect to the dial corresponding to the plurality of distances.

11. The apparatus of claim 3 further comprising at least one gear operatively coupled between the first disk and the second disk.

12. The apparatus of claim 1 further comprising indicia corresponding to the plurality of distances.

13. The apparatus of claim 1 further comprising a support supporting the first beam emitter and the second beam emitter, wherein the first beam emitter and the second beam emitter translate relative to the support between the plurality of positions.

14. The apparatus of claim 1 further comprising a spray gun coupled to the first beam emitter and the second beam emitter.

15. The apparatus of claim 14, wherein the spray gun includes a manually actuatable trigger for initiating spraying and wherein the apparatus further comprises a switch operatively coupled to the trigger, the first beam emitter and the second beam emitter so as to actuate the first beam emitter and the second beam emitter in response to actuation of the trigger and prior to initiation of spraying.

16. The apparatus of claim 1, wherein the first beam emitter and the second beam emitter each comprise a light emitting diode.

17. The apparatus of claim 1 further comprising a power washer coupled to the first beam emitter and the second beam emitter.

18. The apparatus of claim 1, wherein the first beam emitter and the second beam emitter move within different parallel planes.

19. An apparatus comprising:
a source of pressurized fluid;
a spray gun operatively coupled to the source to receive the pressurized fluid and to direct emission of the pressurized fluid;
a first beam emitter; and
a second beam emitter coupled to the first beam emitter so as to move in unison with the first beam emitter between a plurality of positions to indicate a plurality of distances separating the first beam emitter and the second beam emitter from endpoints of beams emitted by the first beam emitter and the second beam emitter.

20. A method comprising:
rotating a first beam emitter and a second beam emitter in unison and in opposite directions between a plurality of positions to indicate a plurality of distances separating the first beam emitter and the second beam emitter from endpoints of beams emitted by the first beam emitter and the second beam emitter; and
emitting pressurized fluid towards the endpoints of the beams.
